(19) United States
(12) Patent Application Publication
(10) Pub. No.: US 2026/0200518 A1
(43) Pub. Date: Jul. 16, 2026

(54) Steer-by-Wire Steering System for a Motor Vehicle

(71) Applicant: Robert Bosch GmbH, Stuttgart (DE)

(72) Inventor: Juergen Hoersch, Gschwend (DE)

(21) Appl. No.: 19/139,337

(22) PCT Filed: Dec. 12, 2023
(86) PCT No.: PCT/EP2023/085307

§ 371 Date: Jun. 14, 2025

(30) Foreign Application Priority Data
Dec. 20, 2022 (DE) 10 2022 213 965.8

(51) Int. Cl. B62D 5/00

(52) U.S. Cl. CPC B62D 5/001

(57) ABSTRACT

A steer-by-wire steering system of a motor vehicle includes a device for mechanically limiting the rotational travel of a steering shaft disposed at least in sections in a housing of the steer-by-wire steering system. The device includes a plurality of stop elements rotatably arranged on the steering shaft. The stop elements are each configured in such a way that the stop surfaces of stop elements arranged adjacent to one another abut one another when the steering shaft rotates. A bore of the respective annular portion of the first stop element and that of the at least one second stop element opposite the steering shaft have a predetermined clearance, which is configured such that the first stop surface and the second stop surface of the respective stop element disposed opposite to it simultaneously abut the stop surfaces of an adjacent stop element.

The invention relates to a steer-by-wire steering system for a motor vehicle.

### PRIOR ART

Various concepts are known in the prior art for implementing a rotational angle limitation of a steering shaft of a steering system, in particular for use in the context of a steer-by-wire steering system.

DE 100 17 049 A1 discloses a steering device for a motor vehicle with a steering handle, which is connected via a steering spindle in rotational communication with it, and a steering gear, wherein the torque connection of the steering spindle to the steering gear may be completed via mechanical, hydraulic, pneumatic or electrical transfer elements, wherein the steering spindle has axial and/or torsion stops on the lower torque side for limiting the rotational angle in both directions of rotation, and wherein counter stops are arranged on the housing side.

The invention is thus based on the object of providing an improved steer-by-wire steering system of a motor vehicle, which has improved properties with regard to a force effect in the end stop.

The object is achieved by means of a steer-by-wire steering system for a motor vehicle having the features of claim 1.

### DISCLOSURE OF THE INVENTION

The present invention creates a steer-by-wire steering system for a motor vehicle.

The steer-by-wire steering system comprises a device for mechanically limiting the rotational speed of a steering shaft, disposed at least in portions in a housing of the steer-by-wire steering system, comprising a plurality of stop elements rotatably disposed on the steering shaft, each of which respectively comprises an annular section, through which the steering shaft is inserted, a first stop surface extending radially from the annular section and a second stop surface disposed opposite to the first stop surface.

Furthermore, a first stop element is rotationally fixedly connected to the steering shaft, wherein at least one second stop element is disposed adjacent the first stop element in the axial direction of the steering shaft.

The stop elements are each configured such that the stop surfaces abut stop elements arranged adjacent to one another when the steering shaft rotates. At least one end stop is disposed on the housing of the steer-by-wire steering system, which is configured to limit a rotation of the steering shaft in both directions of rotation through abutment of the stop element disposed adjacent to the end stop, wherein a bore of the respective annular portion of the first stop element and the at least one second stop element opposite the steering shaft has a predetermined clearance, which is configured such that the first stop surface and the second stop surface of the respective stop element disposed opposite to it simultaneously abut the stop surfaces of an adjacent stop element.

One idea of the present invention is to create an additional degree of freedom with regard to the guide diameter between the steering shaft and the inner circumference of the respective stop elements. Thus, the respective stop element can advantageously change its position within certain limits, thereby avoiding redundancy of the system in that the two opposite stop surfaces of the respective stop element are precisely positioned across from the stop surfaces of the adjacently disposed stop element.

Advantageous embodiments and further developments emerge from the dependent claims and from the description with reference to the drawings.

According to a preferred further development, it is provided that a third stop element is disposed adjacent to the at least one second stop element, wherein the end stop is configured to limit a rotation of the steering shaft in both directions of rotation through abutment of the third stop element.

By providing the third stop element, which is disposed between the second stop element and the end stop, an angle of rotation of the steering shaft can be advantageously increased.

According to another preferred further development, it is provided that the first stop element, the at least one second stop element and the third stop element are configured to form a force couple when torque is introduced due to the first stop surface and the second stop surface abutting against respective stop surfaces of the adjacent stop element.

Thus, individual forces acting on the respective stop surface can be advantageously cut in half. The respective stop element may thereby be dimensioned smaller, whereby cost, weight and construction space may be reduced.

According to another preferred further development, it is provided that the first stop element, the at least one second stop element and the third stop element are configured to limit a rotational distance of the steering shaft without introducing a transverse force on the steering shaft.

As a result, the steering shaft can advantageously be dimensioned smaller, which in turn can also reduce costs, weight and construction space.

According to another preferred further development, it is provided that the clearance is formed by a difference in diameter between a shaft diameter of the steering shaft and a diameter of the bore of the respective stop element. Thus, an optimal size may be selected for the steering shaft and the diameter of the bore of the stop element, which are optimally coordinated with one another.

According to another preferred further development, it is provided that the first stop element, the at least one second stop element and the third stop element are configured, when the first stop surface and the second stop surface abut against the respective stop surfaces of the adjacent stop element to align itself relative to the steering shaft such that an even transmission of force can be carried out from the first stop surface and the second stop surface to respective stop surfaces of the adjacent stop element.

The clearance can therefore be determined advantageously such that it provides exact feedback on the position deviation of the respective stop surfaces of the stop elements.

According to another preferred further development, it is provided that an amount of clearance between the first stop element, the at least one second stop element and the third stop element relative to the steering shaft is substantially greater than or equal to a position deviation of the stop surfaces of adjacent stop elements. The clearance created thereby can be advantageously dampened by grease introduced into the bore of the respective stop element.

According to another preferred further development, it is provided that the position deviation of the stop surfaces of adjacent stop elements is a position deviation along a direction of rotation of the stop elements. This can thus be precisely determined, wherein the required clearance between the steering shaft and the bore diameter of the stop element can then be determined on this basis.

According to another preferred further development, it is provided that the third stop element is configured such that the first stop surface abuts the first stop surface of the adjacently disposed second stop element upon a rotation of the steering shaft in a first direction of rotation, and wherein the second stop surface abuts a third stop surface of the at least one end stop disposed on the housing of the steer-by-wire steering system. Thus, the rotation of the steering shaft may be effectively limited in the first direction of rotation.

According to another preferred further development, it is provided that the third stop element is configured such that the first stop surface abuts the second stop surface of the adjacently disposed second stop element upon a rotation of the steering shaft in a second direction of rotation opposite to the first direction of rotation, and wherein the second stop surface abuts a third stop surface of the at least one end stop disposed on the housing of the steer-by-wire steering system. Thus, the rotation of the steering shaft may be effectively limited in the second direction of rotation.

According to another preferred further development, it is provided that the third stop element is configured to abut simultaneously against one stop surface of the second stop element and one stop surface of the at least one end stop disposed on the housing of the steer-by-wire steering system upon a rotation of the steering shaft. Abutment against the end stop can thus also advantageously be achieved with a uniform force distribution or introduction of torque into the corresponding stop surfaces.

According to another preferred further development, it is provided that a stop surface of the respective stop element comprises a metallic stop surface at least in portions and an attenuation element at least in portions, formed in particular from elastomer. This may, for example, result in the metallic stop surfaces being subjected to less wear.

According to another preferred further development, it is provided that the respective stop elements are configured such that, when the stop surfaces of stop elements disposed adjacent to one another abut one another, the respective attenuation elements come into contact with one another first. An acoustic dampening can thus be advantageously achieved when the respective stop surfaces abut one another.

The described embodiments and refinements may be combined with one another as desired.

Further possible configurations, refinements, and implementations of the invention also comprise not explicitly mentioned combinations of features of the invention described above or below with respect to exemplary embodiments.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the advantages mentioned are shown in the drawings. The illustrated elements of the drawings are not necessarily shown to scale with respect to one another.

The figures show:

FIG. 1 a schematic illustration of a portion of a steer-by-wire steering system of a motor vehicle according to a preferred embodiment of the invention;

FIG. 2a a longitudinal sectional view of the steer-by-wire steering system of the motor vehicle according to the preferred embodiment of the invention.

FIG. 2b shows a longitudinal sectional view of the steer-by-wire steering system of the motor vehicle according to the preferred embodiment of the invention.

FIG. 3 a schematic illustration of a stop element of a steer-by-wire steering system of a motor vehicle not associated with the invention; and

FIG. 4 a schematic illustration of a stop element for the steer-by-wire steering system of the motor vehicle according to the preferred embodiment of the invention.

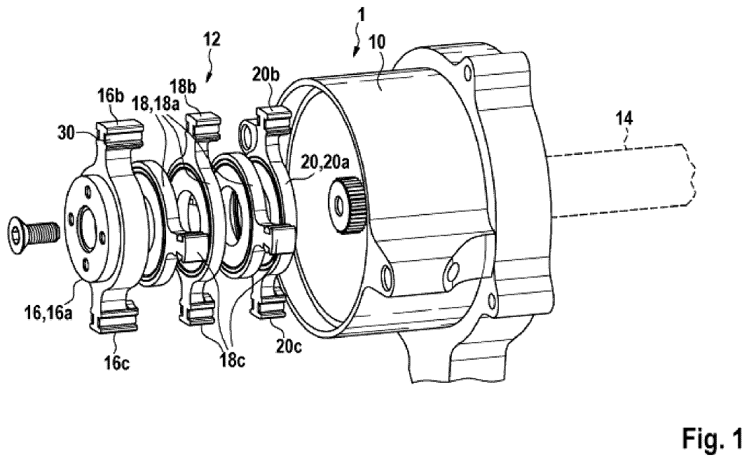

In the figures of the drawings, identical reference numbers denote identical or functionally identical elements, parts or components, unless stated otherwise.

The steer-by-wire steering system 1 for the motor vehicle comprises a device 12 for mechanically limiting the rotational travel of a steering shaft 14, which is disposed at least in sections in a housing 10 of the steer-by-wire steering system 1, comprising a plurality of stop elements 16, 18, 20 rotatably disposed on the steering shaft 14, each of which respectively comprises an annular portion 16a, 18a, 20a, through which the steering shaft 14 is inserted, a first stop surface 16b, 18b, 20b extending radially from the annular portion 16a, 18a, 20a and a second stop surface 16c, 18c, 20c disposed opposite to the first stop surface 16b, 18b, 20b.

A first stop element 16 is rotationally fixedly connected to the steering shaft 14, wherein at least one second stop element 18 is disposed adjacent the first stop element 16 in the axial direction of the steering shaft 14. An optional third stop element 20 is furthermore disposed adjacent the at least one second stop element 18, wherein the stop elements 16, 18, 20 are each configured such that the stop surfaces of stop elements 16, 18, 20 disposed adjacent to one another abut one another when the steering shaft 14 rotates.

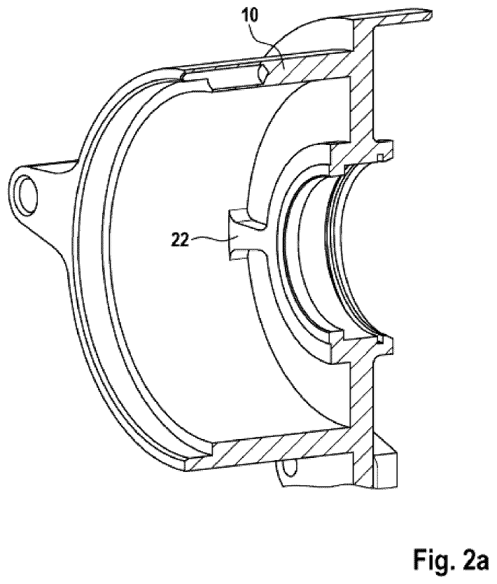

FIG. 2a shows a longitudinal sectional view of the steer-by-wire steering system of the motor vehicle according to the preferred embodiment of the invention.

At least one end stop 22 is disposed on the housing 10 of the steer-by-wire steering system 1, which is configured to limit a rotation of the steering shaft 14 (not shown in FIG. 2a) in both directions of rotation by abutting the third stop element 20.

FIG. 2b shows a longitudinal sectional view of the steer-by-wire steering system of the motor vehicle according to the preferred embodiment of the invention.

At least one end stop 22 is disposed on the housing 10 of the steer-by-wire steering system 1, which is configured to limit a rotation of the steering shaft 14 in both directions of rotation by abutting the third stop element 20.

The third stop element 20 is further configured such that, when the steering shaft 14 rotates in a first direction of rotation, the first stop surface 16b, 18b, 20b abuts the first stop surface 16b, 18b, 20b of the adjacently disposed second stop element 18, wherein the second stop surface 16c, 18c, 20c abuts a third stop surface 26 of the at least one end stop 22 disposed on the housing 10 of the steer-by-wire steering system 1.

The third stop element 20 is furthermore configured such that, when the steering shaft 14 rotates in a second direction of rotation opposite the first direction of rotation, the first stop surface 16b, 18b, 20b abuts the second stop surface 16c, 18c, 20c of the adjacently disposed second stop element 18, wherein the second stop surface 16c, 18c, 20c abuts a fourth stop surface 28 of the at least one end stop 22 disposed on the housing 10 of the steer-by-wire steering system 1.

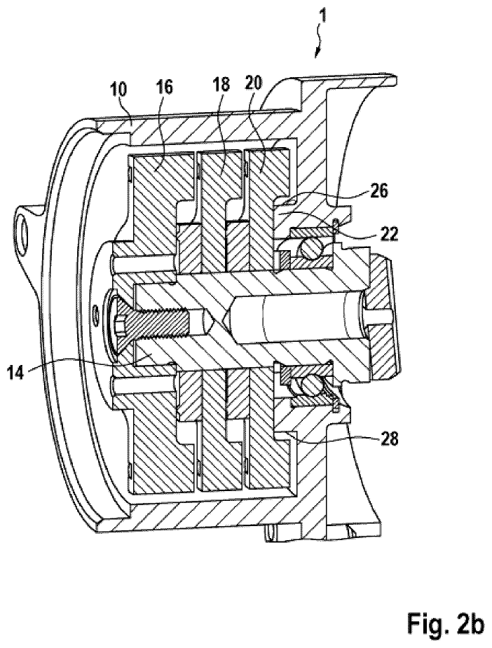

FIG. 3 shows a schematic illustration of a stop element for a steer-by-wire steering system of a motor vehicle not associated with the invention.

The stop elements 16, 18 are configured such that the bore of the respective annular portion 16a, 18a of the first stop element 16 and that of the at least one second stop element 18 have too little play with respect to the steering shaft 14.

Thus, the stop elements 16, 18 are not capable of compensating for a distance or a position deviation 32 between the stop surfaces of adjacent stop elements. This in turn results in an uneven introduction of torque on the stop surfaces of the respective stop element.

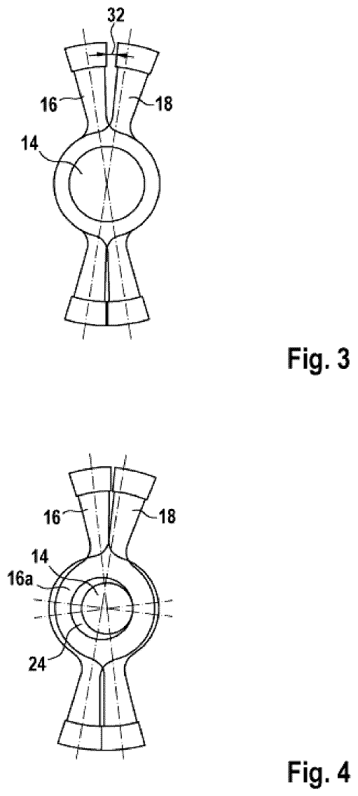

FIG. 4 shows a schematic illustration of a stop element for the steer-by-wire steering system of the motor vehicle according to the preferred embodiment of the invention.

A bore 16a1, 18a1, 20a1 of the respective annular portion 16a, 18a, 20a of the first stop element 16, the at least one second stop element 18 and the third stop element 20 have a predetermined clearance 24 with respect to the steering shaft 14, which is configured such that the first stop surface 16b, 18b, 20b and the oppositely disposed second stop surface 16c, 18c, 20c of the respective stop element 16, 18, 20 simultaneously abut the stop surfaces of an adjacent stop element 16, 18, 20.

The first stop element 16, the at least one second stop element 18 and the third stop element 20 are configured such that they form a force pair when torque is introduced when the first stop surface 16b, 18b, 20b and the second stop surface 16c, 18c, 20c abut respective stop surfaces of the adjacent stop element 16, 18, 20.

Furthermore, the first stop element 16, the at least one second stop element 18 and the third stop element 20 are configured to limit a rotational distance of the steering shaft 14 without introducing transverse force on the steering shaft 14. The clearance 24 is further configured by a difference in diameter between a shaft diameter of the steering shaft 14 and a diameter of the bore 16a1, 18a1, 20a1 of the respective stop element 16, 18, 20.

The first stop element 16, the at least one second stop element 18 and the third stop element 20 are also configured such that, when the first stop surface 16b, 18b, 20b and the second stop surface 16c, 18c, 20c abut respective stop surfaces of the adjacent stop element 16, 18, 20 they align relative to steering shaft 14 such that a uniform transmission of force of the first stop surface 16b, 18b, 20b and the second stop surface 16c, 18c, 20c to the respective stop surfaces of the adjacent stop element 16, 18, 20 may be carried out.

An amount of clearance 24 between the first stop element 16, the at least one second stop element 18 and the third stop element 20 relative to the steering shaft 14 is greater than or equal to a position deviation of the stop surfaces of adjacent stop elements 16, 18, 20. The position deviation of the stop surfaces of adjacent stop elements 16, 18, 20 is a position deviation along a direction of rotation of the stop elements 16, 18, 20.

Furthermore, the third stop element 20 is configured to abut a stop surface of the second stop element 18 and a stop surface of the at least one end stop 22 disposed on the housing 10 of the steer-by-wire steering system 1 simultaneously upon a rotation of the steering shaft 14.

A stop surface of the respective stop element comprises a metallic stop surface at least in portions and an attenuation element 30 at least in portions, formed in particular from elastomer.

The respective stop elements 16, 18, 20 are further configured such that the respective attenuation elements come into contact with one other first when the stop surfaces of stop elements 16, 18, 20 disposed adjacent to one another abut one another.

1. A steer-by-wire steering system for a motor vehicle, comprising:
a housing; and
a device arranged at least in portions in the housing and configured to mechanically limit rotational travel of a steering shaft,
wherein the device includes a plurality of stop elements rotatably disposed on the steering shaft, each of which respectively comprises an annular portion, through which the steering shaft is inserted, a first stop surface radially extending from the annular portion and a second stop surface disposed opposite to the first stop surface,
wherein a first stop element is connected to the steering shaft in a rotationally fixed manner,
wherein at least one second stop element is disposed adjacent the first stop element in the axial direction of the steering shaft,
wherein the stop elements are each configured in such a way that the stop surfaces of stop elements disposed adjacent to one another abut each other upon rotation of the steering shaft,
wherein at least one end stop is disposed on the housing, which is configured to limit rotation of the steering shaft in both directions of rotation by abutting the stop element disposed adjacent the end stop,
wherein a bore of the respective annular portion of the first stop element and of the at least one second stop element has a predetermined clearance with respect to the steering shaft which is configured such that the first stop surface and the second stop surface of the respective stop element disposed opposite to it simultaneously abut the stop surfaces of an adjacent stop element.

2. The steer-by-wire steering system according to claim 1, wherein a third stop element is disposed adjacent the at least one second stop element and wherein the end stop is configured to limit a rotation of the steering shaft in both directions of rotation by abutting the third stop element.

3. The steer-by-wire steering system according to claim 1, wherein the first stop element the at least one second stop element and the third stop element are configured to form a force pair when torque is introduced due to the abutment of the first stop surface and the second stop surface, against respective stop surfaces of the adjacent stop element.

4. The steer-by-wire steering system according to claim 1, wherein the first stop element the at least one second stop element and the third stop element are configured to limit a rotational distance of the steering shaft without introducing a transverse force on the steering shaft.

5. The steer-by-wire steering system according to claim 1, wherein the clearance is configured by a difference in diameter between a shaft diameter of the steering shaft and a diameter of the bore of the respective stop element.

6. The steer-by-wire steering system according to claim 1, wherein the first stop element the at least one second stop element and the third stop element are configured to align relative to the steering shaft when the first stop surface and the second stop surface abut respective stop surfaces of the adjacent stop element such that a uniform transmission of force between the first stop surface and the second stop surface is carried out at respective stop surfaces of the adjacent stop element.

7. The steer-by-wire steering system according to claim 1, wherein an amount of clearance between the first stop element the at least one second stop element and the third stop element with respect to the steering shaft is substantially greater than or equal to a position deviation of the stop surfaces of adjacent stop elements.

8. The steer-by-wire steering system according to claim 7, wherein the position deviation of the stop surfaces of adjacent stop elements is a position deviation along a direction of rotation of the stop elements.

9. The steer-by-wire steering system according to claim 1, wherein the third stop element is configured such that, upon rotation of the steering shaft in a first direction of rotation, the first stop surface abuts the first stop surface of the adjacently disposed second stop element and wherein the second stop surface abuts a third stop surface of the at least one end stop disposed on the housing.

10. The steer-by-wire steering system according to claim 1, wherein the third stop element is configured such that, when the steering shaft rotates in a second direction of rotation opposite to the first direction of rotation, the first stop surface abuts the second stop surface of the adjacently disposed second stop element, and wherein the second stop surface abuts a fourth stop surface of the at least one end stop disposed on the housing.

11. The steer-by-wire system according to claim 1, wherein the third stop element is configured to simultaneously abut a stop surface of the second stop element and abut a stop surface of the at least one end stop disposed on the housing when the steering shaft rotates.

12. The steer-by-wire steering system according to claim 1, wherein a stop surface of the respective stop element comprises a metallic stop surface at least in portions and an attenuation element at least in portions, elastomer.

13. The steer-by-wire steering system according to claim 12, wherein the respective stop elements are configured such that the respective attenuation elements form contact with one another first when the stop surfaces adjacent to one other abut one another.

14. The steer-by-wire steering system according to claim 1, wherein the attenuation element is formed from an elastomer.
